(19) United States
(12) Patent Application Publication
(10) Pub. No.: US 2006/0064222 A1
(43) Pub. Date: Mar. 23, 2006

(54) Kit for providing an automatic steering system

(75) Inventor: Ron Palmer, Regina (CA)

Correspondence Address: FULBRIGHT & JAWORSKI L.L.P., 600 CONGRESS AVE., SUITE 2400, AUSTIN, TX, 78701, US

(73) Assignee: Accurtrak Systems Limited

(21) Appl. No.: 11/231,648

(22) Filed: Sep. 21, 2005

(30) Foreign Application Priority Data
Sep. 21, 2004 (CA) 2,482,281

(51) Int. Cl. G06F 19/00

(52) U.S. Cl. 701/50; 701/213; 701/41

(57) ABSTRACT

An automatic steering kit comprises a microprocessor connectable to a global positioning system and operative to compare the sensed location with a desired vehicle path. A controlled pressure reducing valve provides hydraulic fluid at a reduced pressure less than the vehicle hydraulic supply pressure. Low pressure conduits are connected to the reducing valve and steering conduits. In response to an automatic steering signal generated by the microprocessor, the reducing valve directs hydraulic fluid at the reduced pressure through the low pressure conduits to extend and retract the hydraulic steering cylinder to automatically steer the vehicle. The difference between the reduced pressure and the supply pressure is such that turning the steering wheel will steer the vehicle against the automatic steering force applied through the low pressure conduits. A gyroscope is added to provide improved vehicle steering.

### BACKGROUND OF THE INVENTION

1. Field of the Invention

This invention is in the field of agricultural vehicles and in particular systems for steering such vehicles automatically using a global positioning system.

2. Description of Related Art

Global positioning systems (GPS) are in common use on agricultural tractors, sprayers, and like vehicles. Such systems generally comprise an antenna to pick up signals from satellites circling the globe, and a receiver which translates those signals into location data to establish the location of the vehicle within various tolerances, commonly within inches. The location data is generally transmitted to a microprocessor that can then perform various functions using the GPS data.

The GPS tracks the location of the vehicle over time, and using this location data a microprocessor can provide a steering guide for the vehicle. Typically such agricultural vehicles will be pulling an implement that has a known width, and the object is to cover the entire field by passing back and forth over the field with the edge of the implement located just at the edge of the last pass such that no part of the field is missed, and yet overlap is kept to a minimum.

The width of the implement being used is entered into a microprocessor. The GPS continuously determines the location of the vehicle and the microprocessor tracks and stores the path the vehicle takes as it passes across the field. The microprocessor can thus determine a desired second path adjacent to a first pass by moving the second path over one implement width from the first pass. As the vehicle moves along the field to create the second path, the microprocessor indicates to the vehicle operator the actual location of the vehicle compared to the desired location that is on the second path. In one common system, a light bar is used. A green light in the center of the bar indicates that the vehicle is at the correct location, while yellow lights to each side indicate a variance to the left or right, and the operator steers the vehicle accordingly. Other indicators are also known.

Auto-steering systems have now been developed whereby the microprocessor is used to actually steer the vehicle as opposed to simply indicating to the operator which direction he should steer. Typically the vehicle will be conventionally equipped with a steering actuator, commonly a hydraulic steering cylinder, that is extended and retracted to steer the vehicle in response to signals from the steering wheel of the vehicle. The hydraulic steering cylinder is connected to the hydraulic pump of the vehicle, at a typical supply pressure of 1500 to 2500 pounds per square inch (psi). The steering wheel is connected between the steering cylinder and pump such that turning the wheel directs hydraulic fluid into either one port or the other to extend or retract the hydraulic steering cylinder.

In an auto-steering system, the microprocessor sends steering signals to the steering actuator in addition to the steering wheel. A switch is generally provided to change the source of the steering signals received by the steering actuator back and forth between the microprocessor and the steering wheel. In some systems, an override is provided such that signals from the steering wheel will override signals from the microprocessor.

Using the above example of the light bar indicator, when the light is green, the GPS steering signal would maintain the actuator in its current position. When a yellow light indicates a variance from the desired location that is on the desired path, the GPS steering signal extends or retracts the steering actuator to steer the vehicle toward the desired path. When the GPS senses that the vehicle is at a location that is on the desired path, the GPS steering signal would again maintain the actuator in its current position.

When using a conventional auto-steering system, an operator will typically start out by establishing headlands by making a couple of passes at each end of a field to provide an area for turning the vehicle. The operator then strikes out across the field in the direction desired and establishes an AB line from a starting point A to an ending point B. The GPS establishes this line as the direction desired and then establishes a grid of desired paths parallel to the AB line and separated by the implement width. The operator will turn at the far end of a pass and when generally aligned in the opposite direction with a desired path, the auto-steering system will be activated to assume control of the steering actuator, either automatically or by switching control from the steering wheel to the GPS. Often the auto-steering system will include an audible alarm whereby the microprocessor determines that the previously tracked headland is approaching and warns the operator that he will soon have to make a turn.

In such prior art auto-steering systems, the steering signals from both the steering wheel and the microprocessor use the same hydraulic pressure, typically the supply pressure of 1500 to 2500 psi. A simple on/off solenoid valve could be used to direct oil to the hydraulic steering cylinder in response to steering signals from the microprocessor, however such simple on/off valves result in jerky steering action. As the high pressure hydraulic fluid source is abruptly connected to the steering cylinder, and then disconnected, the steering cylinder moves quickly and stops quickly. For that reason, more costly proportional valves are commonly used with a hydraulic steering cylinder in order to reduce this jerky effect.

Such automatic steering systems are conventionally provided as a kit for installation on agricultural vehicles. One farm may have two or more agricultural vehicles on which it would be advantageous to use such an automatic steering system, for example chemical applicators, tractors pulling seeders and the like, and so forth. Conventionally, it is time consuming and problematic to move the system from one agricultural vehicle to another and so a complete kit is usually installed on any vehicle where it is desired to be used.

A further problem with such GPS auto-steering systems is that the GPS signal lags the actual location of the vehicle by a short while, typically 1-3 seconds. The GPS can only sense the direction of the vehicle based on where it was compared to where it is at a given time. Vehicle steering systems are not perfect and tend to wander somewhat. Also vehicles can be pushed off course by hitting a rock, ditch, or the like, and on hillsides gravity will pull them off course as well. Thus when the vehicle is moved off course or wanders, and given the time lag inherent in the GPS, misses and overlaps can result, and drastic corrections may be required. Such changes are sensed and then implemented by sending a steering signal to the steering actuator which turns the vehicle sharply.

### SUMMARY OF THE INVENTION

It is an object of the present invention to provide an automatic steering kit for attachment to an agricultural vehicle that overcomes problems in the prior art.

The present invention provides an automatic steering kit for attachment to an agricultural vehicle. The agricultural vehicle comprises a hydraulic fluid system operative to supply pressurized hydraulic fluid; an extendable hydraulic steering cylinder connected to the hydraulic fluid system by first and second steering conduits; a steering wheel operatively connected to the first and second steering conduits and operative, when turned, to direct a flow of hydraulic fluid at a supply pressure through the first and second steering conduits to extend and retract the hydraulic steering cylinder to steer the vehicle; and a global positioning system operative to determine a sensed location of the vehicle and operative to generate and send a corresponding location signal. The automatic steering kit comprises a microprocessor adapted for operative connection to the global positioning system to receive the location signal, and operative to compare the sensed location with a desired vehicle path, and operative to generate and send an automatic steering signal calculated to steer the agricultural vehicle on the desired path; a controlled pressure reducing valve operatively connected to the microprocessor to receive the automatic steering signal, and adapted for connection to the hydraulic fluid system and operative to provide hydraulic fluid to one of first and second ports thereof at a reduced pressure that is less than the supply pressure; first and second low pressure conduits connected to respective first and second ports at one end thereof and adapted for connection to respective first and second steering conduits by T-fittings. In response to the automatic steering signal, the controlled pressure reducing valve is operative to direct a flow of hydraulic fluid at the reduced pressure through the first and second low pressure conduits to extend and retract the hydraulic steering cylinder to automatically steer the vehicle. When the kit is attached to the agricultural vehicle, a difference between the reduced pressure and the supply pressure is such that turning the steering wheel will steer the vehicle against an automatic steering force applied to the hydraulic steering cylinder through the first and second reduced pressure conduits.

The kit may be adapted to two different agricultural vehicles by providing a controlled pressure reducing valve on each vehicle, and wiring an enclosure containing the microprocessor into the valve and GPS with quick release connectors. The low pressure automatic control steers the vehicle smoothly, and the steering wheel can be turned at any time to over-ride the automatic steering.

For improved operation, a gyroscope can be added that immediately senses lateral movement of the vehicle so that the microprocessor can then determine if the lateral movement was planned, as in a programmed steering correction to maintain the desired path, or unplanned and so caused by faults in the steering system or an obstacle or like occurrence. The microprocessor then sends a corrective automatic steering signal if required based on the lateral movement and whether same was planned. Thus unplanned lateral movements can be quickly detected and corrected, and the time lags inherent in a GPS are avoided.

### BRIEF DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a schematic view of an embodiment of the invention installed on an agricultural vehicle;

FIG. 2 is schematic view of enclosure showing the releasable attachment to the vehicle and controlled pressure reducing valve that facilitates transfer of the enclosure from one vehicle to another;

FIG. 3 is a schematic top view of the operation of an auto-steering system;

FIG. 4 is a schematic top view illustrating the difference between the operation of an auto-steering system with a gyroscope and that of a prior art system without a gyroscope.

### DETAILED DESCRIPTION OF THE ILLUSTRATED EMBODIMENTS

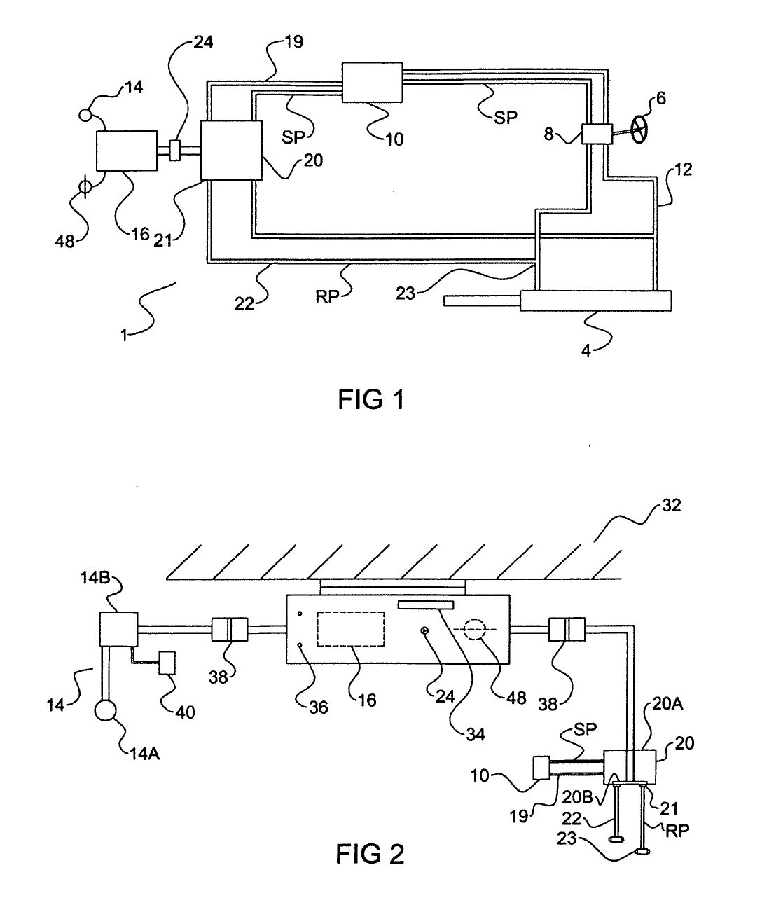

FIG. 1 schematically illustrates an automatic steering kit 1 attached to the hydraulic and steering systems of an agricultural vehicle such as a tractor, self-propelled sprayer, or the like. The agricultural vehicle comprises an extendable hydraulic steering cylinder 4 connected to a hydraulic fluid system 10 by steering conduits 12. A steering wheel 6 is operatively connected to the steering conduits 12 through a steering valve 8 and is operative, when turned, to direct a flow of hydraulic fluid, received from the hydraulic fluid system 10 at a supply pressure SP, through the steering conduits 12 to extend and retract the hydraulic steering cylinder 4 to steer the vehicle. The agricultural vehicle also includes a global positioning system 14 operative to determine a sensed location of the vehicle and operative to generate and send a corresponding location signal. A global positioning system 14 is often already installed on an agricultural vehicle where it is desired to install the kit of the invention, and the kit is adapted to use such an existing system. Alternatively the required global positioning system 14 can be installed at the same time as the automatic steering kit.

For installation on the agricultural vehicle described, an automatic steering kit of the invention comprises a microprocessor 16 adapted for operative connection to the global positioning system 14 to receive the location signal. The microprocessor 16 is operative to compare the sensed location with a desired vehicle path, and generate and send an automatic steering signal calculated to steer the agricultural vehicle on the desired path.

A controlled pressure reducing valve 20 is operatively connected to the microprocessor 16 to receive the automatic steering signal. The reducing valve 20 is adapted for connection to the hydraulic fluid system 10 of the agricultural vehicle at a suitable location, such as will be readily recognized by those skilled in the art, by supply conduits 19 and is operative to provide hydraulic fluid to ports 21 thereof at a reduced pressure RP that is less than the supply pressure SP of the hydraulic fluid system 10.

Low pressure conduits 22 are connected to ports 20 at one end thereof and are adapted for connection to respective steering conduits 12 by T-fittings 23. In response to the automatic steering signal received from the microprocessor 16, the controlled pressure reducing valve 20 is operative to direct a flow of hydraulic fluid at the reduced pressure RP through the low pressure conduits 22 to extend and retract the hydraulic steering cylinder 4 to automatically steer the vehicle.

The difference between the reduced pressure RP and the supply pressure SP is such that turning the steering wheel 6 will steer the vehicle against an automatic steering force applied to the hydraulic steering cylinder 4 through the reduced pressure conduits 12. For example the supply pressure SP will typically be between 1500 and 2500 psi, while the reduced pressure RP will typically be 400 to 600 psi. When the steering wheel 6 is at rest, there is no flow of hydraulic fluid through the steering conduits 12. The reduced pressure hydraulic fluid in low pressure conduits 22 will then flow as instructed by the automatic steering signal controlling the controlled pressure reducing valve 20. If however the steering wheel 6 is turned, the lower pressure fluid in low pressure conduits 22 will be overcome by the higher pressure fluid from the steering conduits 12, and the hydraulic steering cylinder 4 will extend or retract as directed by the steering wheel 6.

A mode switch 24 is connected to the microprocessor 16 and is operative, in an automatic mode, to enable the controlled pressure reducing valve 20 to receive the automatic steering signal, and is operative, in a manual mode, to prevent the controlled pressure reducing valve 20 from receiving the automatic steering signal. Regardless of whether the mode switch 24 is in manual or automatic mode, the steering wheel 6 at all times will over-ride and control the steering, allowing sudden steering changes that might be required because of an obstacle or the like, without switching from automatic to manual mode.

FIG. 2 schematically illustrates a kit of the invention wherein the microprocessor 16 is mounted in an enclosure 30 such as a plastic case or the like. The enclosure 30 is releasably attached to some portion 32 of the agricultural vehicle in proximity to an operator's position by a Velcro™ fastener, attachment bracket, or the like. The mode switch 24 is mounted on the enclosure 30 and a display 34 is typically provided as well to display operating information and so forth. One or more input buttons 36 allow the operator to enter the width of the implement, and other parameters that might be convenient or required for operation.

The global positioning system 14 comprises an antenna 14A connected to a receiver 14B. Typically the receiver 14B is also connected to the electrical power supply 40 of the agricultural vehicle. The microprocessor 16 is connected to the receiver 14B of the global positioning system via a releasable connector 38, and also receives electrical power from the vehicle through this connection as well. The microprocessor 16 is also connected to the controlled pressure reducing valve 20 via another releasable connector 38. Thus the enclosure and microprocessor can be removed from the agricultural vehicle simply by releasing the connectors 38 and pulling the enclosure 30 to unfasten the Velcro™ fastening.

The controlled pressure reducing valve 20 includes a conventional pressure reducing valve 20A operative to reduce the supply pressure SP from the hydraulic fluid system 10 at the input ports thereof to the lesser reduced pressure RP at the output ports 21 thereof, and a solenoid 20B connected to the microprocessor 16 and operative to open and close the ports 21 in response to the automatic steering signal generated by the microprocessor 16. The relatively low reduced pressure RP in the low pressure conduits 22 does not exert sufficient force to move the hydraulic steering cylinder abruptly, and allows the use of a relatively inexpensive on/off solenoid 20B instead of more expensive proportional valves as in the prior art.

The kit of the invention thus comprises essentially the enclosure 30 with the microprocessor 16 and mode switch 24, electrical conductors with the releasable connectors 38, the controlled pressure reducing valve 20 with appropriate hardware to fasten same to the agricultural vehicle, supply conduits 19 of a length sufficient to tap into the hydraulic fluid system 10 of the vehicle, and low pressure conduits 22 with T-fittings 23 of a length sufficient to connect into the steering conduits 12 at some convenient location along their length.

With such a kit, two vehicles with global positioning systems can share the automatic steering advantages. A controlled pressure reducing valve 20 is plumbed into the hydraulic system 10 and steering conduits 12 of each vehicle, and the electrical conductors are wired into the controlled pressure reducing valve 20, global positioning system 14, and the electrical power supply 40 of each vehicle. The enclosure 30 can then be conveniently transferred from one vehicle to the other.

The illustrated kit of the invention also includes a gyroscope 48 mounted inside the enclosure 30 and connected to the microprocessor 16 and electrical power supply 12. The gyroscope 48 is operative to determine lateral movement of the vehicle and send a corresponding movement signal to the microprocessor 16. The microprocessor 16 is programmed to receive the location signal from the global positioning system 14 and the movement signal from the gyroscope 48, and compare the sensed location and lateral movement with a desired vehicle path and then generate the automatic steering signal.

Conveniently the gyroscope 48 can be oriented to spin about a generally horizontal axis to better sense lateral movement. The vehicle turns and changes direction around the gyroscope which remains stable. By measuring the relationship between the stable gyroscope 48 and the vehicle the direction of lateral movement of the vehicle, and the rate or speed of that movement, can be determined immediately and sent to the microprocessor 16. Such gyroscopes 48 require periodic correction to maintain the accuracy of the direction measurement, and so the microprocessor 16 is programmed to calculate a vehicle direction from a plurality of location signals from the global positioning sensor 14, and periodically correct the gyroscope such that the sensed direction of the vehicle corresponds to the calculated vehicle direction.

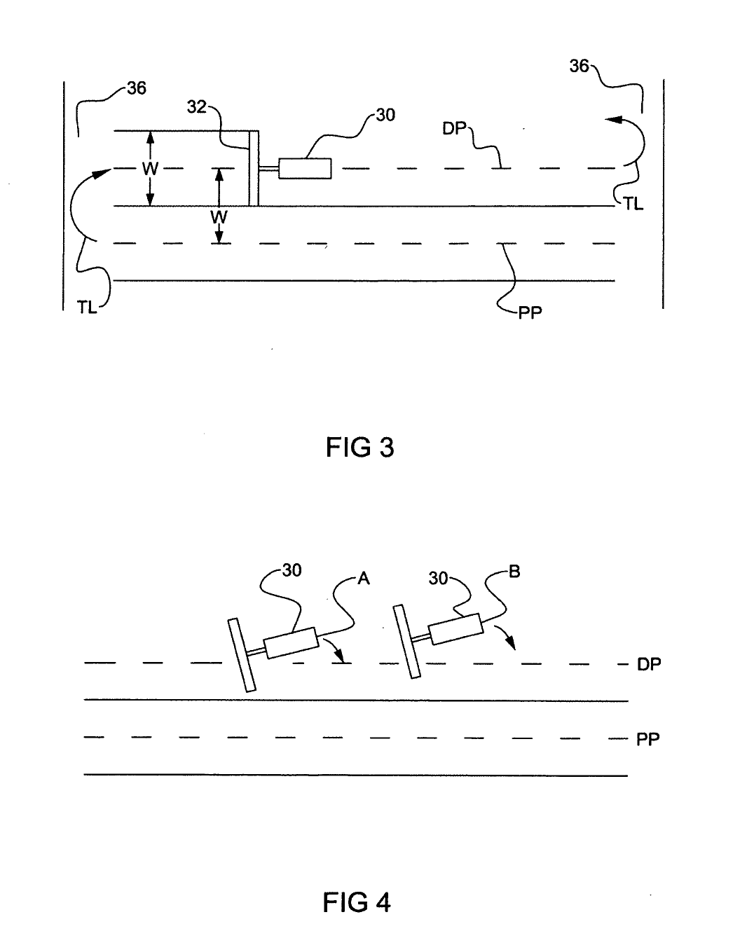

FIG. 3 schematically illustrates the operation of a typical GPS auto-steering system mounted on an agricultural vehicle 30 pulling an implement 32 and moving in direction T. The implement 32 has a width W such that the desired path DP is a distance W from the previous path PP. In FIG. 3 the vehicle 2 is traveling on level land with no obstructions, and illustrates an ideal operation of an auto-steering system.

FIG. 4 schematically illustrates a situation where the vehicle 30 wanders off course, or hits a rock or the like, and moves off the desired path to position A. The movement of the vehicle 30 is somewhat exaggerated for demonstration purposes. The gyroscope immediately senses a lateral movement indicating that the vehicle 30 is turning, and sends a movement signal to the microprocessor.

The microprocessor detects that there has been no location signal from the global positioning sensor indicating that the vehicle 30 is off the desired path DP and so requires a steering correction. The microprocessor thus determines that the movement is not a planned or desirable movement, and sends a steering signal to the steering actuator to steer the vehicle 30 back in a direction opposite to the sensed movement. The rate and amount of movement can be used to determine the approximate correction required, which will be checked against the sensed location from the global positioning sensor.

Since the gyroscope senses the direction change immediately and sends that information to the gyroscope, and the microprocessor processes that information very quickly, only a small steering correction is required.

With only the global positioning sensor guiding the vehicle 30, the time lag inherent in the GPS will mean that the vehicle 30 will travel off course for a longer period of time before the deviance is detected and correction made, to a point illustrated as point B. At point B the vehicle 30 is farther off course than at point A, and a more drastic correction is required.

The addition of the gyroscope thus reduces misses and overlaps caused by deviation of the vehicle 30 from the desired path DP. In addition, smaller steering corrections are required resulting in smoother operation.

The microprocessor can be programmed to record a turning location TL where the vehicle 30 changes direction, such as at the headlands 36 adjacent to the ends of the field in FIG. 3, and to activate an alarm when the vehicle 30 next approaches the turning location TL. Thus it is not necessary to make passes at the headland 36, as in the prior art, in order to record the location thereof for warning the operator when the end of a pass is approaching and a turn is required. Often an operator may wish to make the passes to cover the headlands last, and this option is thus available.

Thus the foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

I claim:

1. For attachment to an agricultural vehicle comprising a hydraulic fluid system operative to supply pressurized hydraulic fluid; an extendable hydraulic steering cylinder connected to the hydraulic fluid system by first and second steering conduits; a steering wheel operatively connected to the first and second steering conduits and operative, when turned, to direct a flow of hydraulic fluid at a supply pressure through the first and second steering conduits to extend and retract the hydraulic steering cylinder to steer the vehicle; and a global positioning system operative to determine a sensed location of the vehicle and operative to generate and send a corresponding location signal, an automatic steering kit comprising:
a microprocessor adapted for operative connection to the global positioning system to receive the location signal, and operative to compare the sensed location with a desired vehicle path, and operative to generate and send an automatic steering signal calculated to steer the agricultural vehicle on the desired path;
a controlled pressure reducing valve operatively connected to the microprocessor to receive the automatic steering signal, and adapted for connection to the hydraulic fluid system and operative to provide hydraulic fluid to one of first and second ports thereof at a reduced pressure that is less than the supply pressure;
first and second low pressure conduits connected to respective first and second ports at one end thereof and adapted for connection to respective first and second steering conduits by T-fittings;
wherein, in response to the automatic steering signal, the controlled pressure reducing valve is operative to direct a flow of hydraulic fluid at the reduced pressure through the first and second low pressure conduits to extend and retract the hydraulic steering cylinder to automatically steer the vehicle; and
wherein, when the kit is attached to the agricultural vehicle, a difference between the reduced pressure and the supply pressure is such that turning the steering wheel will steer the vehicle against an automatic steering force applied to the hydraulic steering cylinder through the first and second low pressure conduits.

2. The kit of claim 1 further comprising a mode switch connected to the microprocessor and operative, in an automatic mode, to enable the controlled pressure reducing valve to receive the automatic steering signal, and operative, in a manual mode, to prevent the controlled pressure reducing valve from receiving the automatic steering signal.

3. The kit of claim 2 wherein the mode switch is mounted on the microprocessor and the microprocessor is adapted for releasable operative connection to the global positioning system, the controlled pressure reducing valve, and an electrical power supply of the agricultural vehicle.

4. The kit of claim 1 further comprising a gyroscope operative to determine lateral movement of the vehicle, and operative to send a corresponding movement signal to the microprocessor, and wherein the microprocessor receives the location signal and the movement signal and compares the sensed location and lateral movement with a desired vehicle path and generates the automatic steering signal.

5. The kit of claim 3 further comprising a gyroscope operative to determine lateral movement of the vehicle, and operative to send a corresponding movement signal to the microprocessor, and wherein the microprocessor receives the location signal and the movement signal and compares the sensed location and lateral movement with a desired vehicle path and generates the automatic steering signal, and wherein the gyroscope and microprocessor are mounted in an enclosure adapted for releasable attachment to the agricultural vehicle in proximity to an operator's position.

6. The kit of claim 4 wherein the microprocessor calculates a calculated vehicle direction from a plurality of location signals, and periodically corrects the gyroscope such that the sensed direction of the vehicle corresponds to the calculated vehicle direction.

7. The kit of claim 5 wherein the microprocessor calculates a calculated vehicle direction from a plurality of location signals, and periodically corrects the gyroscope such that the sensed direction of the vehicle corresponds to the calculated vehicle direction.

8. The kit of claim 4 wherein the gyroscope spins about a substantially horizontal axis.

9. The kit of claim 5 wherein the gyroscope spins about a substantially horizontal axis.

10. The kit of claim 6 wherein the gyroscope spins about a substantially horizontal axis.

11. The kit of claim 7 wherein the gyroscope spins about a substantially horizontal axis.

12. The kit of claim 1 wherein the microprocessor is operative to record a turning location where the vehicle reverses direction, and is further operative to activate an alarm when the vehicle next approaches the turning location.

13. The kit of claim 2 wherein the microprocessor is operative to record a turning location where the vehicle reverses direction, and is further operative to activate an alarm when the vehicle next approaches the turning location.

14. The kit of claim 3 wherein the microprocessor is operative to record a turning location where the vehicle reverses direction, and is further operative to activate an alarm when the vehicle next approaches the turning location.

15. The kit of claim 4 wherein the microprocessor is operative to record a turning location where the vehicle reverses direction, and is further operative to activate an alarm when the vehicle next approaches the turning location.

16. The kit of claim 5 wherein the microprocessor is operative to record a turning location where the vehicle reverses direction, and is further operative to activate an alarm when the vehicle next approaches the turning location.

17. The kit of claim 12 wherein the microprocessor is operative to record a turning location where the vehicle reverses direction, and is further operative to activate an alarm when the vehicle next approaches the turning location.
